(19) United States
(12) Patent Application Publication
(10) Pub. No.: US 2008/0122821 A1
(43) Pub. Date: May 29, 2008

(54) LUMINANCE CONTROL FOR A DISPLAY

(75) Inventors: Rene Nilsson, Eslov (SE); Martin Ek, Dalby (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/614,632

(22) Filed: Dec. 21, 2006

Related U.S. Application Data
(60) Provisional application No. 60/867,154, filed on Nov. 24, 2006.

(51) Int. Cl. G09G 5/00

(52) U.S. Cl. 345/207; 345/211; 345/690

(57) ABSTRACT

A portable device may include at least one image recording device having a first light sensitive unit configured to record an image and detect first light conditions related to the portable device; a display to render the recorded image; and an illumination device to illuminate the display, wherein the illumination device is configured to control an illumination of the display based on the detected first light conditions.

### RELATED APPLICATIONS

This application claims priority under 35 U.S.C. § 119 based on U.S. Provisional Application Ser. No. 60/867,154, filed Nov. 24, 2006, the disclosure of which is incorporated herein by reference.

### TECHNICAL FIELD OF THE INVENTION

The present invention relates to portable devices including an imaging system and, more particularly, to a method and an arrangement for controlling a display in an imaging system of a portable device.

### BACKGROUND OF THE INVENTION

Portable imaging devices are often provided with at least one camera for recording images captured by a user of the device. Recently, imaging devices have been digitalized, and traditional light sensitive silver-based film has been replaced by an electronic light sensitive receiver, e.g., such as a charge-coupled device (CCD) or similar device. In current portable devices, it has become increasingly common to use CMOS image sensors, such as. active pixel sensors (APS). In contrast to CCDs° CMOS image sensors can be made at standard manufacturing facilities that produce 90% of all semiconductor chips which, e.g., results in economies of scale. In addition, APS architectures consume much less power that their CCD counterparts. This is a clear advantage in battery-dependent portable devices.

Typically, modern imaging devices are also provided with a display for presenting images or similar media. In many portable imaging devices, the display is capable of being used both as a view finder and for reproducing images or similar media that has been previously recorded. A common display unit is the liquid crystal display (LCD). An LCD is typically a thin, flat display device made up of any number of color or monochrome pixel arrayed in front of a light source or reflector. The LCD may use minimal amounts of electric power and is thus suitable for use in portable battery-powered electronic devices.

Most LCDs are either transmissive or reflective, based on the location of the illumination source. A transmissive LCD is typically illuminated “from behind” by a backlight and viewed at an opposing front side. Such LCDs may be used in applications requiring high luminance levels such as computer displays, televisions, personal digital assistants (PDAs), and mobile phones, etc. The backlight used to illuminate the LCD in such products is usually consuming much more power than the LCD itself. Portable imaging devices with transmissive displays can be used in various environments spanning a wide range of ambient light levels. Because the human eye is adaptive to various light levels, it is often the case that the luminance of the display is adjusted with respect to the dark adaptation of the human eye.

Reflective LCDs, on the other hand, are typically illuminated by external light sources (e.g., sunlight, artificial indoor lighting, etc.) reflected by a reflector located behind the display. Such LCDs can produce darker ‘blacks’ than transmissive LCDs since light must effectively traverse the liquid crystal layer twice and thus is attenuated twice. Because the reflected light is also attenuated twice in the translucent parts of the display image, however, contrast is usually poorer than in a transmissive display. However, the absence of an internal illumination device significantly reduces the power consumption, allowing for longer battery life in battery-powered devices; small reflective LCDs typically consume so little power that they can rely on a photovoltaic cell, as is often found in digital watches, pocket calculators, etc. The absence of an internal illumination by default also makes the display dependent on the ambient light level and, in this regard, it follows the adaptation of the human eye.

From the above, it should be appreciated that LCDs and similar display devices consume rather small amounts of electric power. Moreover, the illumination device (backlight) used in more demanding applications to illuminate an LCD and similar displays consumes much more power than the display device itself. To significantly reduce the power consumed by a LCD or a similar display device provided with an illumination device (e.g., a backlight), it would thus be beneficial to reduce the power consumed by the illumination device. Additional benefits are to be gained by an adjustment of the illumination of an LCD or similar type of display to the level that corresponds to the adaptation exhibited by the human eye.

In some applications, the power consumed by the backlight of an LCD can be effectively reduced or even eliminated after an initial use of the LCD. This may be the case, for example, once an voice call has been established in a wireless phone, since the LCD is typically not used (i.e., illuminated) during such call. However, current communication devices often provide video-conversation which invoke operation of the LCD or similar display of the device during a portion or an entire conversation, for example, to display the party with whom the user of the phone is communicating.

Power consumed by the illumination device or similar component of an existing LCD can be reduced, as described, for example, in U.S. patent application Publication No. 2003/0210221 (Aleksic). In Aleksic, a phototransistor or a photodiode detects an amount of ambient light that is incident on the LCD screen of a portable device. The LCD screen is illuminated by a backlight in a conventional manner and the power provided to the backlight is adjustable based on the ambient light detected by the phototransistor or photodiode. As more ambient light is detected, less power is provided to the backlight, and vice-versa.

One consideration of this arrangement, however, is that it involves an extra dedicated sensor device (i.e., a phototransistor or a photodiode). The extra mechanism increases the component costs of the portable device. Moreover, the extra sensor requires additional space and an additional opening in the portable device, which increases the manufacturing costs and the overall size and complexity of the functional design of the portable device.

Hence, it would be beneficial to provide a method and an arrangement for a simple, flexible, and accurate detection of the light conditions surrounding a portable device so as to enable a reduction of the power consumed by the illumination device of a display in the portable device, and so as to enable an adjustment of the illumination of the display to correspond to the inherent adaptation of the human eye. In particular, it would be beneficial to provide such a beneficial method and arrangement without having to add any substantial auxiliary hardware to a portable device.

### SUMMARY OF THE INVENTION

The present invention is directed to providing a user of a portable imaging device with a simple, flexible, and accurate detection of the light conditions external to a portable device so as to enable a reduction of the power consumed by the illumination device of a display in the portable device, and so as to enable an adjustment of the illumination of the display to correspond to the inherent adaptation of the human eye to light levels. In particular, implementations of the present invention use existing components in portable imaging devices to achieve such illumination control.

One implementation of the present invention thus provides a user of a portable imaging device with a simple, flexible, and accurate detection of the light conditions surrounding a portable device so as to enable a reduction of the power consumed by the illumination device of a display in the portable device, and/or so as to enable an adjustment of illumination levels of the display based on the inherent adaptation of the human eye.

According to a first aspect of the invention which provides a portable device that includes at least one image recording arrangement having a light sensitive unit for recording images of the environment surrounding the device; and a display arrangement for reproducing recorded images, which display is provided with an illumination device for illuminating the display. The portable device is characterized in that: the at least one image recording arrangement is arranged for operatively detecting the light conditions surrounding the portable device; and said illumination device is arranged to operatively alter the illumination of the display depending on the light conditions detected by said at least one image recording arrangement.

A second aspect of the invention is directed to a device including the features of the first aspect and characterized in that a first imaging recording arrangement is arranged on the same side of the portable device as the display for operatively detect the light conditions on that side of the device.

A third aspect of the invention is directed to a device including the features of the first or second aspects and characterized in that a second imaging recording arrangement is arranged on the opposite side of the portable device compared to the display for operatively detect the light conditions on that side of the device.

A fourth aspect of the invention is directed to a device including the features of the third aspect and characterized in that the second imaging recording arrangement is provided with a removable translucent light scattering unit.

A fifth aspect of the invention is directed to a device including the features of the third aspect and characterized in that the second imaging recording arrangement is arranged for operatively detect the light conditions in addition to the detection made by the first image recording arrangement.

A sixth aspect of the invention is directed to a device including the features of the fourth aspect and characterized in that said second imaging device is arranged for operatively detect the light conditions when said first imaging device detects a complex light condition.

A seventh aspect of the invention is directed to a device including the features of any preceding aspect and characterized in that the light sensitive unit of said image recording arrangement is arranged to operatively provide an average of the light detected by the unit.

An eight aspect of the invention is directed to a device including the features of any preceding aspect and characterized in that the light sensitive unit of said image recording arrangement is provided with a sub-area that is arranged to operatively detect the light conditions surrounding the device.

A ninth aspect of the invention is directed to a device including the features of any preceding aspect and characterized in that the light sensitive unit of said image recording arrangement is provided with a plurality of spatially separated sub-areas that are arranged to operatively detect the light conditions surrounding the device.

A tenth aspect of the invention is directed to a device including the features of the eight or ninth aspect and characterized in that at least one of said sub-areas is limited to a few pixels.

An eleventh aspect of the invention is directed to a device including the features of the first aspect and characterized in that the portable device is a portable communication device.

A twelfth aspect of the invention is directed to a device including the features of the first aspect and characterized in that the portable communication device is a cell phone.

Implementations according to a thirteenth aspect of the present invention directed to a method for controlling the luminance in a portable device, which portable device includes at least one image recording arrangement having a light sensitive unit for recording images of the environment surrounding the device; and a display arrangement for reproducing recorded images, which display is provided with an illumination device for illuminating the display. The method is characterized by detecting the light conditions surrounding the portable device by said at least one image recording arrangement; and altering the illumination of the display by said illumination device depending on the light conditions detected by said at least one image recording arrangement.

A fourteenth aspect of the invention is directed to a method including the features of the thirteenth aspect and characterized by the step of using a first imaging recording arrangement being arranged on the same side of the portable device as the display for detecting the light conditions on that side of the device.

A fifteenth aspect of the invention is directed to a method including the features of the thirteenth or fourteenth aspect and characterized by the step of using a second imaging recording arrangement being arranged on the opposite side of the portable device compared to the display for detecting the light conditions on that side of the device.

A sixteenth aspect of the invention is directed to a method including the features of the fifteenth aspect and characterized by the step of using the second imaging recording arrangement provided with a removable translucent light scattering unit.

A seventeenth aspect of the invention is directed to a method including the features of the fifteenth aspect and characterized by the step of using the second imaging recording arrangement for detecting the light conditions in addition to the detection made by the first image recording arrangement.

An eighteenth aspect of the invention is directed to a method including the features of the sixteenth aspect and characterized by the step of using said second imaging device for detecting the light conditions when said first imaging device detects a complex light condition.

A nineteenth aspect of the invention is directed to a method including the features of the fifteenth aspect and The method in any of the preceding claims characterized by the step of providing an average of the light detected by the light sensitive unit of said image recording arrangement.

A twentieth aspect of the invention is directed to a method including the features of any of the thirteenth to the nineteenth aspect and characterized by the step of using a sub-area in the light sensitive unit of said image recording arrangement to detect the light conditions surrounding the device.

A twenty-first aspect of the invention is directed to a method including the features of any of the thirteenth to the twentieth aspect and characterized by the step of using a plurality of spatially separated sub-areas in the light sensitive unit of said image recording arrangement to detect the light conditions surrounding the device.

A twenty-second aspect of the invention is directed to a method including the features of twentieth or the twenty-first aspect and characterized by the step of using one or several sub-areas being limited to a few pixels.

A twenty-third aspect of the invention is directed to a method including the features of the thirteenth aspect and characterized by the step of using a portable device in the form of a portable communication device.

A twenty-fourth aspect of the invention is directed to a method including the features of the thirteenth aspect and characterized by the step of using a portable device in the form of a cell phone.

A twenty-fifth aspect of the invention is directed to a computer program product stored on a computer usable medium, including readable program means for causing a portable device to execute, when said program means is loaded in the portable device that includes at least one image recording arrangement having a light sensitive unit for recording images of the environment surrounding the device; a display arrangement for reproducing recorded images, which display is provided with an illumination device for illuminating the display, the acts of detecting the light conditions surrounding the portable device by said at least one image recording arrangement; and altering the illumination of the display by said illumination device depending on the light conditions detected by said at least one image recording arrangement.

A twenty-sixth aspect of the invention is directed to a computer program element having a program recorded thereon, where the program is to make a portable device to execute, when said program means is loaded in the portable device including at least one image recording arrangement having a light sensitive unit for recording images of the environment surrounding the device; a display arrangement for reproducing recorded images, which display is provided with an illumination device for illuminating the display, the acts of detecting the light conditions surrounding the portable device by said at least one image recording arrangement; and altering the illumination of the display by said illumination device depending on the light conditions detected by said at least one image recording arrangement.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIGS. 1 and 2 show an exemplary device in which systems and methods described herein may be implemented;

FIG. 3 shows a network in which systems and methods described herein may be implemented;

FIG. 4 is a functional diagram of various components of the device in FIGS. 1-3;

FIG. 5 shows a user utilizing the device in FIGS. 1-4;

FIG. 6 shows a flow chart of a method of performing the method according to a preferred embodiment of the invention; and

FIG. 7 shows a CD ROM on which program code for executing the method according to the invention is provided.

### DETAILED DESCRIPTION OF EMBODIMENTS

The present invention relates to portable devices having an imaging system, such as a camera arrangement. In particular, the invention relates to a communication device including an imaging system. It should be appreciated that the invention is not limited to communication devices. Rather, implementations of the invention can be applied to any suitable portable device that includes a suitable imaging system.

The terms “image” or “images” are intended to comprise still images, a series or sequence of images, as well as moving images, unless otherwise is explicitly stated or is clear from the context.

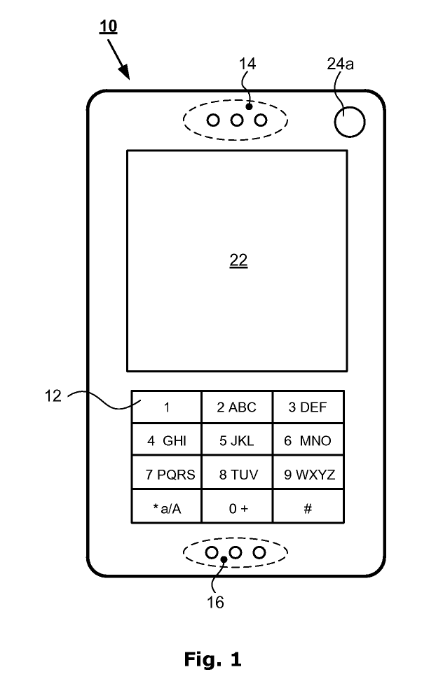

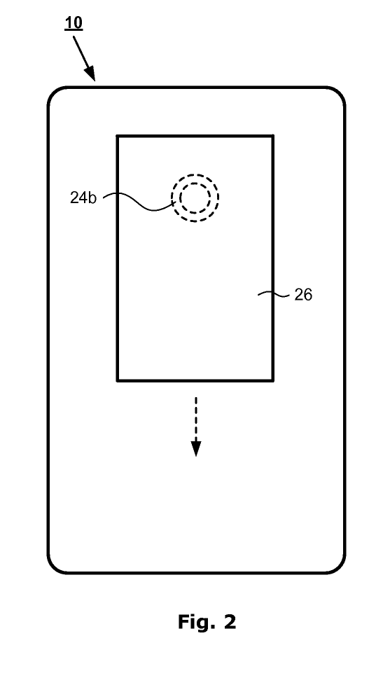

A portable communication device according to one embodiment of the present invention is shown in FIGS. 1 and 2. The device may include a phone 10, such as a mobile cell phone, adapted to operate according to 3G-technology (e.g., W-CDMA or CDMA2000) or possibly according to 2,5-technology (e.g., GPRS) or other communication technology. Information about 3G-technology and 2,5-technology, etc., can be found, for example, in specifications from the 3^{rd} Generation Partnership Project (3GPP), available, for example, at www.3gpp.org.

As shown in FIG. 1, phone 10 may include a keypad 12, a loudspeaker 14, and a microphone 16. Keypad 12 may be configured to be used for entering information, such as selection of functions and responding to prompts. Keypad 12 may include any suitable type of input mechanisms, including push-buttons, touch-buttons, and/or a combination of different suitable button arrangements. Loudspeaker 14 may be used to render sounds to a user of phone 10. Microphone 16 may be used to sense audible (e.g., voice) input from the user. In addition, phone 10 may includes an antenna to be used for communication with other devices via a network. The antenna may be in-built in phone 10 and hence not shown in FIG. 1.

Further, the first side of phone 10 shown in FIG. 1 may include a display 22 for presenting functions and prompts to a user of phone 10. Display 22 may also be used for rendering images. Display 22 may be arranged to present images previously recorded as well as images currently captured or recorded. In other words, in one implementation, display 22 may be arranged to operate both as a presentation device for previously recorded images and as a viewfinder for presenting images currently captured by a camera or similar device.

In one implementation, display 22 may include a transmissive LCD or a similar display device that is adapted to be arranged in portable device of limited dimensions, e.g., such as phone 10. Display 22 may be illuminated by an illumination device 22a (FIG. 4), e.g., a so-called backlight. A backlight function may be accomplished, for example, by electroluminescence (EL), at least one light emitting diode (LED), cold cathode fluorescent lamp (CFL), and/or other suitable device.

Furthermore, the first side of phone 10 may include a first camera arrangement 24a to enable objects viewable to phone 10 to be digitally recorded as images appearing therein. In one embodiment, first camera arrangement 24a may include at least one lens and an image sensor 25a, such as. a CMOS-sensor. Image sensor 25a may build on an integrated circuit containing an array of pixels, each containing a photo detector as well as three or more transistors. First camera arrangement 24a may include a video-conversation camera for recording images of a user of phone 10 during a video-conversation, for example.

A second side of phone 10 may include a second camera arrangement 24b, as shown in FIG. 2. Second camera arrangement 24b may include the same or similar basic structures and functions as first camera arrangement 24a, for example, including an image sensor 25b (FIG. 4). Alternatively, second camera arrangement 24b may be the “principle” camera of phone 10 and thus second camera arrangement 24b may exhibit an enhanced performance relative to first camera arrangement 24a, for example, a higher resolution. Second camera arrangement 24b may be provided with a protective cover in the form of a translucent light scattering unit 26 that can be displaceably removed from camera arrangement 24b as indicated, for example, by the arrow in FIG. 2 and as will be explained in more detail below.

It should be appreciated that phone 10 schematically illustrated in FIGS. 1 and 2 is simply one example of a portable communication device in which the invention may be implemented. In addition, the invention can for instance be used in another type of mobile terminal, such as a PDA (personal digital assistant), a palm top computer, a lap top computer, a smartphone, or any other suitable portable device.

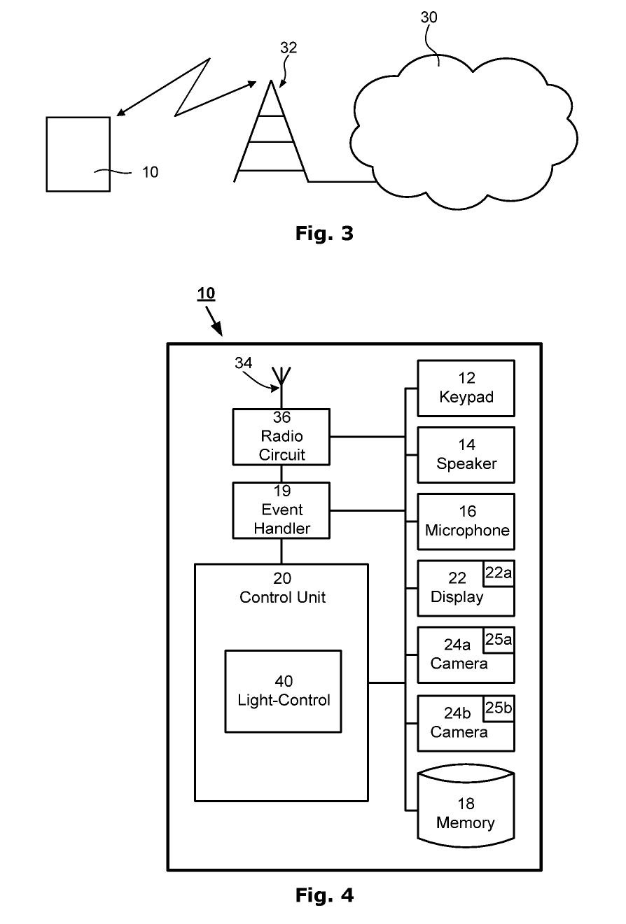

FIG. 3 shows phone 10 connected to a cellular network 30 via a base station 32. Network 30 may include a 3G network such as a WCDMA network, a GPRS network or any other 2,5G or 2,75G network. In addition, network 30 may include other than a cellular network for example, such as the Internet, a corporate intranet, a LAN, PSTN, or a wireless LAN.

FIG. 4 shows functional components of phone 10 in one implementation of the present invention. As previously explained, phone 10 may include keypad 12, speaker 14, microphone 16, display 22 including illumination device 22a, first camera arrangement 24a, and second camera arrangement 24b. In addition, phone 10 nay include a memory 18 to store data files, for example, image files produced by camera arrangement 24a. Memory 18 may be any suitable memory type that is typically used in portable devices.

In addition, phone 10 may include an antenna 34 connected to a radio circuit 36 to enable radio communication with network 30 (FIG. 2). Radio circuit 36 may connect to an event handling unit 19 to handle events, such as outgoing and incoming communication to and from external units via network 30, for example, calls and messages, e.g., SMS (Short Message Service) and MMS (Multimedia Messaging Service).

Phone 10 may include a control unit 20 to control and/or monitor the operation of phone 10. Control unit 20 may be implemented using hardware and/or software, and it may include one or several hardware units and/or software modules, e.g., one or several processor units provided with or having access to the appropriate software and hardware for enabled functions provided by phone 10.

As can be seen in FIG. 4, control unit 20 may connect to keypad 12, speaker 14, microphone 16, memory 18, event handling unit 19, display 22, camera arrangements 24a and 24b, and radio unit 36 via, for example, a bus. Control unit 20 may thereby control and communicate with the individual units so as to, e.g., exchange information and/or instructions with the units.

Exemplary cell phones such as phone 10 described above with reference to FIGS. 1-4, i.e., provided with first camera arrangement 24a for video-conversations and second camera arrangement 24b to record high quality images, are exhibited, for example, in Sony-Ericsson mobile cellular phones P990i, W850i, K610i and Z610i. The basic structure and function of such cell phones are well known to those skilled in the art and thus a detailed description need not be provided herein.

Implementations of the present invention provide a light-control 40 including a control unit 20. Being a part of control unit 20 implies that light-control 40 may be implemented by means of hardware and/or software and it may include one or several hardware units and/or software modules, for example, one or several processor units provided with or having access to the software and hardware appropriate for the functions provided. Light-control 40 may be arranged to operatively control amounts of electric power provided to illumination device 22a (backlight) associated with display 22 based on a detection of the light conditions surrounding phone 10, as will be described in more detail below.

It should be appreciated that, in addition to the parts and units schematically illustrated in FIG. 4, further parts and units or similar components may be included with phone 10. The parts and units shown in FIG. 4 may also connect to more parts and units in addition to those illustrated.

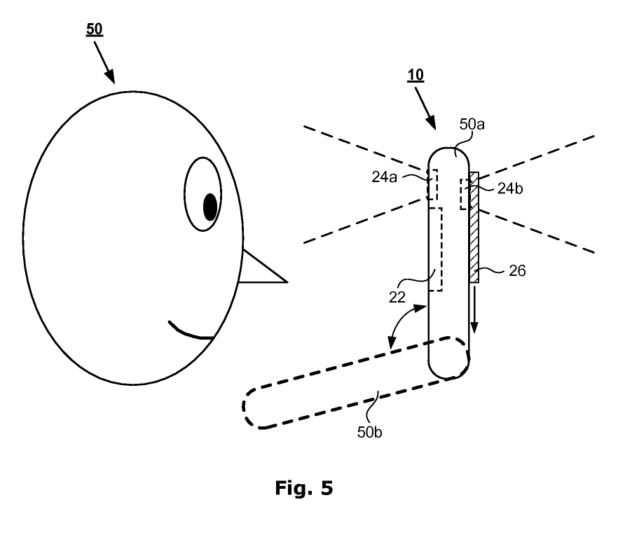

FIG. 5 shows phone 10 being operated by a user 50 utilizing phone 10, for example, for a video-conversation according to one embodiment of the present invention. Assume, for this example, that phone 10 is maintained so that first camera arrangement 24a can record images that include portions of user 50. The recorded images may be transmitted by phone 10 via, for example, network 30 to another party to the video-conference. During a video-conversation, user 50 may gaze at display 22, which may reproduce images of the other party to the video-conversation. Assume the reproduced images of the other party have been recorded by a camera similar to first camera arrangement 24a and they are transmitted to phone 10 via network 30, as will be appreciated by those in skilled in the art.

Phone 10 may include a single first body 50a. Phone 10 may include first body 50a and a second body 50b being pivotally connected to each so as to create a flip-phone, as is well known in the art. Second body 50b is shown in FIG. 5 by means of dashed lines to illustrate that the foldable feature is an alternative embodiment.

According to one implementation of the present invention, at least first camera arrangement 24a—in addition to being arranged for producing images during video-conversations—may be arranged to acquire information concerning the light conditions in which phone 10 is being operated. In this manner, the light conditions can be detected by means of an existing component. Hence, use of an extra dedicated sensor or similar device, e.g., a phototransistor or a photodiode as described in the U.S. patent application No. 2003/0210221 (Aleksic), is obviated. Moreover, since an existing component is utilized, no additional space or additional openings or other modification are required for phone 10. Compared to the technique proposed in Aleksic, implementations of the present invention may result in decreased costs in the overall design and operational complexity of phone 10.

According to one implementation, an indication or measurement corresponding to the amount of light detected at first camera arrangement 24a may be communicated to light-control 40. Light-control 40 may be configured to provide power to illumination device 22a associated with display 22 based on the light information received from first camera arrangement 24a. For example, light-control 40 may be configured to provide a first predetermined amount of power to illumination device 22a associated with display 22 as more light is detected and, alternatively, a second predetermined amount of power as less light is detected. The relation between the amount of light detected by first camera arrangement 24a and the amount of power provided to illumination device 22a by light-control 40 can be defined, for example, in a look-up table stored in memory 18 associated with phone 10. The look-up table can be based, for example, on mathematical relations, empirical experiences obtained in laboratory environments (e.g., research and development), and/or in actual use conditions.

In one implementation, first camera arrangement 24a and display 22 may be arranged on a same side of phone 10. Such arrangement may increase the likelihood that first camera 24a may detect an accurate measure of the light incident upon display 22 in circumstances characterized by non-uniform lighting.

In another implementation, second camera arrangement 24b—in addition to being arranged as a primary-use camera for producing high quality images—may likewise be arranged to detect the lighting conditions to which phone 10 is being subjected.

Second camera arrangement 24b may be arranged on the rear side of phone 10, whereas display 22 may be arranged on an opposing front side. Second camera arrangement 24b may thus be used for providing an indirect measure of the external light to which display 22 may be exposed. Furthermore, second camera arrangement 24b may be utilized to detect the light conditions secondarily to the detection made by first camera arrangement 24a. Thus, additional lighting information may be provided for conditions associated with the use of phone 10, which enables a more accurate detection and precise determination of the light conditions affecting visual acuity associated with the use of phone 10 (i.e., display 22).

For example, phone 10 may be used in complex light conditions including, for example, several very bright and/or very dark surfaces/areas or other light gradients. For example, phone 10 may be used in a shadowy area while first camera arrangement 24b may be directed toward a very bright surface outside the shadowed area. In this situation, the light conditions detected and provided by first camera arrangement 24a may be less relevant to visibility of display 22, while the light conditions detected and provided by second camera arrangement 24b may be of more relevance.

Further, in complex light situations, it may be selected to detect the light incident upon phone 10, instead of using camera arrangements 24a, 24b using techniques for detecting the light reflected from various surfaces in proximity to phone 10. Properties of incident light and reflected light may be appreciated by, for example, skilled photographers. One technique of measuring the light incident upon an object is to use an integrating sphere or another type of refracting device along with a light sensing device. This technique makes the light detection less sensitive to the reflectance of particular surfaces in the environs surrounding the light sensing device. For example, a translucent hemispherical plastic dome may be used to approximate an integrating sphere.

A translucent dome or similar device arranged so as to obscure first camera arrangement 24a may inhibit recording of an image of a user of phone 10, for example, during a video-conversation. Second camera arrangement 24b, on the other hand, not being used for video-conversations or other similar functions, may be effectively provided with a device for measuring the light incident upon phone 10. In one embodiment of the invention, second camera arrangement 24b may be provided with a translucent light scattering unit 26. Light scattering unit 26 may include a type of semi-transparent white plastic (or other material) that is positionable at least partially in front of second camera arrangement 24b, for example, as a protective cover. In a picture taking mode of second camera arrangement 24b, on the other hand, light scattering unit 26 may be turned, slid, or otherwise displaced relative to second camera arrangement 24b (and the lens thereof) so that scattering unit 26 does not substantially effect the light detected by second camera arrangement 24b, e.g., slid in an unobstructive direction as indicated by the arrow in FIG. 1 and FIG. 5.

In some embodiments, phone 10 may be of a type of structure and/or design that is more sensitive than others manually handling by the user so the hand and/or fingers at least partially obstruct second camera arrangement 24b. For example, a non foldable cell phone may be held at body 50a shown in FIG. 5 including the second camera arrangement 24b, and thus be more sensitive to the position of the user's hand and fingers. Alternatively, a foldable phone may be held at body 50b shown in FIG. 5 including no camera and thus be less sensitive to the position of the user's hand and fingers. In other words, before a measurement from second camera arrangement 24b is used, it may be desirable to determine whether light scattering unit 26 is substantially evenly illuminated and/or that the amount of light detected by second camera arrangement 24b is above a certain fraction of the amount of light being detected by first camera arrangement 24a (i.e., that second camera arrangement 24b is not obstructed). The relation between the amount of light detected by second camera arrangement 24b and the amount of light detected by first camera arrangement 24a indicating a reliable use of second camera arrangement 24b can be defined, for example, in a look-up table stored in memory 18 associated with phone 10. The look-up table can be based, for example, on mathematical relations, on empirical experiences obtained in laboratory environments, in actual use, etc.

In one embodiment of the present invention, the light measured by an array in image sensor 25a and/or 25b (e.g., a CMOS-sensor) or a similar light sensitive array of at least one of camera arrangements 24a, 24b may be used in tandem, i.e., combined (e.g., averaged), to provide a single output value. This approach may be used in most existing digital cameras and an advantage with using the approach is that the basic function provided by standard digital cameras can be utilized.

In another embodiment of the present invention, a dedicated sub-area in the array of light sensitive elements in image sensor 25a and/or 25b or similar device used in the camera arrangements 24a, 24b may be used for detecting the light conditions surrounding phone 10. The dedicated sub-area may include a fraction of the total number of pixels in the array of light sensitive elements, e.g., 1-100, 10-90, 20-80, 30-70, 40-60, 1-50, 5-45, 15-35, 1-25, 1-10, 2-9, 3-8, 4-7, 5-6, 1-5, 2-4, 1-3, or any other number of pixels. Compared to utilizing the entire image recorded by image sensor 25a and/or 25b or similar device, this represents a substantial simplification of the light detection function. For example, averaging a measure from a few pixels may provide a substantial simplification compared to averaging a measure from each pixel in the entire image, which would also tend to delay the detection and increase the power consumption.

In still another embodiment of the present invention, the array of light sensitive elements in image sensor 25a and/or 25b or similar device used in at least one of camera arrangements 24a, 24b may be divided into several spatially separated sub-areas each being arranged to separately detect the light conditions surrounding phone 10. For example, each such sub-area may include a predetermined number of pixels as described above. This technique may enable information about the complexity of the light conditions surrounding phone 10 to be obtained, e.g., so as to differentiate between relatively bright and relatively dark areas in the image recorded by either of camera arrangements 24a, 24b. This information can be selectively used for increasing a likelihood that the amount of light detected by camera arrangements 24a, 24b corresponds to the amount of light actually incident upon phone 10, which in turn increases the likelihood that light-control 40 may provide illumination device 22a with the minimum effective amount of power to create a clearly visible image via display 22 from the user's perspective.

For example, as discussed above, first camera arrangement 24a may detect light that is reflected from one or more surfaces proximate to phone 10 and the detection may be, therefore, sensitive to the reflectance of the particular surface(s). If the spatially separated sub-areas of image sensor 25a and/or 25b or similar device detects a complex light condition, it may be desirable to discount, ignore, or otherwise distinguish the detection from first camera arrangement 24a, since the amount of light detected by first camera arrangement 24a in a complex light situation may not correspond to the amount of light actually incident upon phone 10. A measurement detected by second camera arrangement 24b may alternatively be used by light-control unit 40 to determine an amount of power to be provided to illumination device 22a associated with display 22. This is particularly so for implementations in which second camera arrangement 24b is provided with light scattering unit 26 or similar device for measuring incident light as discussed above. However, if neither first camera arrangement 24a nor second camera arrangement 24b may be reliably used (second camera arrangement 24b may be blocked, for example, by a finger(s) of the user, etc.), it may be desirable to set the amount of power provided to illumination device 22a at a predetermined default level, at least until at least one of camera arrangements 24a, 24b can be used to obtain reliable information.

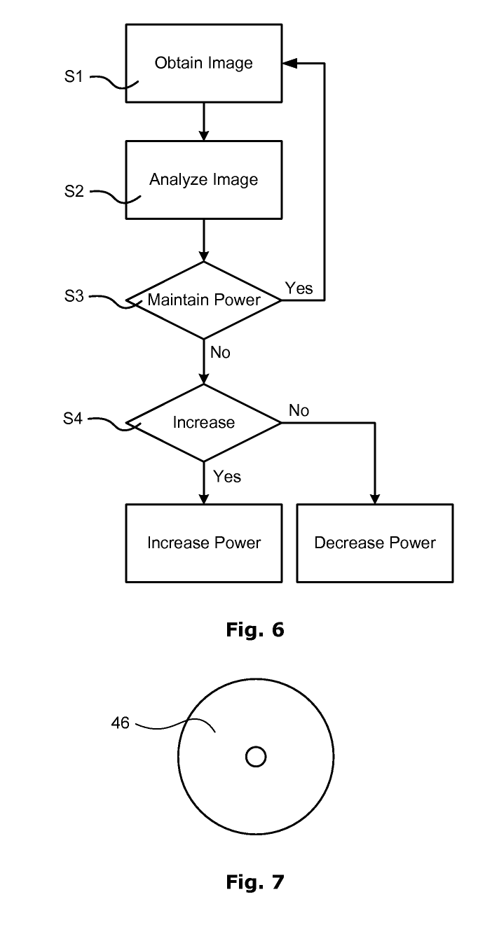

The function of an exemplifying embodiment of the present invention will now be described with reference to FIGS. 1-5, together with FIG. 6, which shows a flow chart of one embodiment of a method according to the invention.

Operations in an exemplifying method of controlling amounts of electric power provided to illumination device 22a of display 22 based on a detection of the light conditions associated with use of phone 10 to be performed using first camera arrangement 24a and/or second camera arrangement 24b will now be described with reference to the exemplifying flow chart in FIG. 6. The method may be implemented, for example, using light-control 40, as schematically illustrated in FIG. 4.

In a first step S1, of the exemplifying method, according to one embodiment of the present invention, an image may be obtained by at least first camera arrangement 24a. The obtained image or at least a portion of the obtained image may be made available to light-control 40. As previously explained, the part(s) of the obtained image made available to light-control 40 may correspond to the light detected by a few pixels of image sensor 25a and/or 25b or similar device provided as a light sensitive receiver in camera arrangement 24a.

In a second step S2 of the exemplifying method, the received image or portion thereof may be analyzed by light-control 40. The image may be analyzed, for example, by using a suitable algorithm for obtaining the luminance of pixels in the received image. As mentioned above, the image may be obtained using image sensor 25a and/or 25b or similar device, and those skilled in the art, having the benefit of this disclosure, may recognize a vast variety of methods suitable for retrieving and analyzing the light detected by pixels in image sensor 25a and/or 25b. For example, the algorithm may retrieve a full image recorded by camera arrangement 24a and then concentrate the analyzing activity to one or a few selected areas within the image, which areas may include only a few pixels. Retrieving and analyzing the properties of the pixels in a digital image may be appreciated by those skilled in the art without further description.

In a third step S3 of the exemplifying method, it may be determined whether the amount of power provided to illumination device 22a should be maintained or changed depending on the luminance level obtained for the analyzed pixels in the image as described in the previous step S3. As previously mentioned, the relation between the amount of light detected by first camera arrangement 24a and the amount of power provided to illumination device 22a by light-control 40 can be defined, for example, in a look-up table stored in memory 18 associated with phone 10. The method may return to step S1 upon a determination that the current power level should be maintained. Otherwise, the method will proceed to the next step (i.e., S4).

In a fourth step S4 of the exemplifying method, the amount of power provided to the illumination device 22a may be adjusted, that is, increased or decreased. Naturally, the steps S1 to S4 may be repeated continuously during the operation of display 22, or as instructed by input received from the user.

In general, as previously explained, light-control 40, arranged to perform the exemplifying method described above, may be provided in the form of one or more processors with corresponding memory containing the appropriate software in the form of a program code, for instance. Alternatively, the program code may be provided on a data carrier such as a CD ROM disc 46 as depicted in FIG. 7 or an insertable memory stick, which will perform the invention when loaded into a computer or into a phone having suitable processing capabilities. The program code may be downloaded remotely from a server either outside or inside the cellular network or be downloaded via a computer like a PC to which the phone is temporarily connected.

The present invention has now been described with reference to exemplifying embodiments. However, the invention is not limited to the embodiments described herein. On the contrary, the full extent of the invention is only determined by the scope of the appended claims.

What is claimed is:

1. A portable device comprising;
at least one image recording device having a first light sensitive unit configured to record an image and detect first light conditions related to the portable device;
a display to render the recorded image; and
an illumination device to illuminate the display, wherein the illumination device is configured to control an illumination of the display based on the detected first light conditions.

2. The portable device in claim 1, wherein the at least one image recording device is disposed on a same side of the portable device as the display.

3. The portable device in claim 1, further comprising:
a second image recording device having a second light sensitive unit configured to detect second light conditions related to the portable device, wherein the second image recording device is disposed on a different side of the portable device than the display.

4. The portable device in claim 3, further comprising:
a displaceable translucent light scattering unit configured to at least partially cover the second image recording device.

5. The portable device in claim 3, wherein the illumination device is configured to control the illumination of the display based on the detected second light conditions.

6. The portable device in claim 5, wherein the second image recording device is configured to operatively detect the second light conditions when the first image recording device detects a complex light condition.

7. The portable device in claim 1, wherein the first light sensitive unit is configured to determine an average amount of the light detected by the light sensitive unit.

8. The portable device in claim 1, wherein the first light sensitive unit includes a sub-area that is configured to operatively detect the first light conditions.

9. The portable recording device in claim 1, wherein the first light sensitive unit of includes a plurality of spatially separated sub-areas that are arranged to operatively detect the first light conditions.

10. The portable device in claim 9, wherein at least one of said sub-areas comprises a predetermined number of pixels.

11. The portable device in claim 1, wherein the portable device is a portable communication device.

12. The portable device in claim 11, wherein the portable communication device is a cell phone.

13. A method of controlling luminance in a portable device that includes at least one camera unit having a light sensor and a display having an illumination device, the method comprising:
detecting, a first camera unit, first ambient lighting;
controlling, by the illumination device, illumination of the display based on the detected first ambient lighting.

14. The method in claim 13, wherein the detecting the first ambient lighting comprises detecting an amount of light proximate the display.

15. The method in claim 14, further comprising:
detecting, by a second camera unit, second ambient lighting at a side of the portable device opposing the display.

16. The method in claim 15, wherein detecting the second ambient lighting comprises receiving light at the second camera unit via a translucent light scattering unit.

17. The method in claim 15, further comprising:
controlling, by the illumination device, the illumination of the display based on the detected second ambient lighting.

18. The method in claim 16, wherein the detecting the second ambient light occurs when said first camera unit detects a complex light condition.

19. The method in claim 1, wherein the detecting the first ambient lighting includes determining an average of the first ambient lighting.

20. The method in any of the claim 1, wherein the detecting the first ambient lighting includes using a sub-area in the light sensor to detect the first ambient lighting.

21. The method in claim 1, wherein the detecting the first ambient lighting includes using a plurality of spatially separated sub-areas in the light sensor detect the first ambient lighting.

22. The method in claim 21, wherein the using the spatially separated sub-areas includes using one or several sub-areas comprising a predetermined number of pixels.

23. The method in claim 13, wherein the portable device comprises a portable communication device.

24. The method in claim 23, wherein the portable communication device comprises a cell phone.

25. A computer-readable storage medium executable in a portable device that includes at least one camera unit having a light sensor and a display having an illuminator, the computer-readable storage medium comprising:
instructions to:
detect the lighting conditions proximate the portable device by the at least one camera unit; and
control illumination of the display by the illuminator based on the detected lighting conditions.

26. A portable device comprising;
means for recording an image and detecting an amount of light at the portable device;
means for rendering the recorded image; and
means for illuminating the rendered recorded image based on the amount of light.
